(19) United States
(12) Patent Application Publication
(10) Pub. No.: US 2026/0359576 A1
(43) Pub. Date: Nov. 12, 2026

(54) AI-BASED METHODS AND SYSTEMS FOR PREVENTING CYBERBULLYING

(71) Applicant: Álvaro Fernández Güell, Barcelona (ES)

(72) Inventor: Álvaro Fernández Güell, Barcelona (ES)

(21) Appl. No.: 19/199,755

(22) Filed: May 6, 2025

(51) Int. Cl. G06F 40/40; G06F 16/3329; G06F 16/334; G06F 40/30; H04L 51/212

(52) U.S. Cl. CPC G06F 40/40; G06F 16/33295; G06F 16/3344; G06F 40/30; H04L 51/212

(57) ABSTRACT

A computer-implemented method for detecting offensive messages in a computer system comprises receiving a first data from a first computing device comprising a message sent to a recipient user; accessing a database that stores a second data comprising one or more examples of offensive messages and explanations of why they are offensive; reading the second data from the database; generating a text prompt comprising instructions, the first data, and the second data, where the instructions comprise a first instruction for a large language model system to assign a probability that the message of the first data is offensive considering the one or more examples of offensive messages of the second data; transmitting the text prompt to the large language model system; and receiving an output text generated by the large language model system comprising an indicator of the probability that the message of the first data is offensive.

### TECHNICAL FIELD

The present disclosure relates generally to artificial intelligence and, more specifically to methods and systems using artificial intelligence for preventing cyberbullying.

### BACKGROUND

This section provides background information related to the present disclosure which is not necessarily prior art.

Cyberbullying has become a pervasive issue in the digital age, affecting individuals of all ages, particularly children and teenagers. Cyberbullying generally refers to the use of digital platforms, such as social media, messaging apps, and online forums, to harass, intimidate, or humiliate others. Unlike traditional forms of bullying, cyberbullying is persistent, sometimes anonymous, and has a far-reaching impact due to the rapid dissemination of information online.

One of the major concerns of cyberbullying is its psychological impact. Victims often experience anxiety, depression, low self-esteem, and, in extreme cases, suicidal tendencies. Studies have shown that cyberbullying can be more damaging than face-to-face bullying due to the permanence and public nature of online harassment. Additionally, the anonymity provided by digital platforms allows perpetrators to act without fear of immediate consequences, making it difficult for victims to seek justice or protection.

Another critical challenge is the difficulty of detection and prevention of cyberbullying. Unlike physical bullying, which often occurs in observable environments like schools or workplaces, cyberbullying takes place in private digital spaces. Parents, teachers, and law enforcement authorities frequently struggle to identify incidents until significant harm has already occurred. Moreover, current measures for combating cyberbullying, such as content moderation and reporting mechanisms, are often insufficient or reactive rather than proactive.

The growing concern over cyberbullying has led to increased efforts by governments, technology companies, and advocacy groups to implement policies and technological solutions aimed at mitigating its effects. However, existing solutions remain fragmented and limited in their effectiveness. Therefore, there is a critical need for innovative approaches that can effectively detect, prevent, and mitigate the impact of cyberbullying, ensuring a safer digital environment for all users.

In recent years, social media platforms have implemented text moderation powered by artificial intelligence to automatically detect and remove insults. However, cyberbullies have become increasingly sophisticated, using hate messages without insults and with double meanings and coded language that current text moderation technologies fail to detect. This evolving challenge highlights the limitations of existing AI-driven moderation systems and underscores the need for more advanced and adaptive solutions to combat online harassment effectively.

### SUMMARY

This section provides a general summary of the present disclosure and is not a comprehensive disclosure of its full scope or all of its features.

One object of the present disclosure is to provide AI-based methods and systems for preventing cyberbullying.

According to one embodiment, a computer-implemented method for detecting offensive messages in a computer system comprises receiving in the computer system a first data from a first computing device, the first data comprising a message sent to a recipient user; accessing a database from the computer system, where the database stores a second data comprising one or more examples of offensive messages and explanations of why the one or more examples of offensive messages are offensive; reading in the computer system the second data from the database; generating in the computer system a text prompt, the text prompt comprising instructions, the first data, and the second data, where the instructions are in a first human language and comprise a first instruction for a large language model system to assign a probability that the message of the first data is offensive considering the one or more examples of offensive messages of the second data; transmitting from the computer system the text prompt to the large language model system; and receiving in the computer system an output text generated by the large language model system, the output text comprising an indicator of the probability that the message of the first data is offensive.

In one embodiment, the indicator is a number.

In some embodiments, the method further comprises comparing in the computer system the number of the output text with a threshold level; determining in the computer system that the message of the first data is not offensive; and transmitting from the computer system the message of the first data to a second computing device associated with the recipient user.

In some embodiments, the method further comprises comparing in the computer system the number of the output text with a threshold level; determining in the computer system that the message of the first data is offensive; and transmitting from the computer system to the first computing device a third data that indicates that the message of the first data cannot be sent to the recipient user.

In one embodiment, the output text further comprises an explanation of the reason why the message is offensive.

In one embodiment, the third data comprises an explanation of the reason why the message is offensive.

In one embodiment, the explanations of why the one or more examples of offensive messages are offensive are previously received by the recipient user and are stored in the database by the recipient user.

In one embodiment, the instructions of the text prompt further comprise a second instruction for the large language model to consider if the message of the first data has a double meaning.

In one embodiment, the instructions of the text prompt further comprise a third instruction for the large language model to assign a high probability of the message of the first data being offensive when the message is equal or similar to the one or more examples of offensive messages of the second data.

In one embodiment, the first data further comprises an identifier of a second human language used in the first computing device.

In one embodiment, the instructions of the text prompt further comprise a fourth instruction for the large language model system to use a second human language to generate at least a part of the output text.

In one embodiment, the at least a part of the output text generated in the second human language comprises the reason why the message is offensive.

In one embodiment, the first human language is the same as the second human language.

In one embodiment, the first human language is different than the second human language.

In one embodiment, the one or more examples of offensive messages of the second data are previously received by the recipient user.

In one embodiment, the one or more examples of offensive messages of the second data are preconfigured offensive messages.

In one embodiment, the one or more examples of offensive messages of the second data are associated with a category of hate or intolerance.

In one embodiment, the hate or intolerance category pertains to at least one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In one embodiment, the hate or intolerance category is selected by the recipient user.

### BRIEF DESCRIPTION OF THE DRAWINGS

Other advantages and features of the present disclosure can be seen in the following detailed description in which, with a non-limiting character, different embodiments are referred to in relation to the accompanying drawings, wherein:

FIG. 1 shows an example of a computer system and a large language model system used in some embodiments;

FIG. 2 shows an example of a social networking system and a second artificial intelligence used in some embodiments;

FIG. 3 shows an example of a method executed in a computer system according to some embodiments where a database stores examples of offensive messages;

FIG. 4a shows an example of a method executed in a computer system according to some embodiments where a large language model system detects a category of hate;

FIG. 4b shows an example of a method executed in a computer system according to some embodiments where a large language model system detects a category of hate and uses it to select preconfigured examples of offensive messages;

FIG. 5 shows an example of a method executed in a computer system according to some embodiments;

FIG. 6 shows an example of a method executed in a computing device according to some embodiments where a database stores examples of offensive messages;

FIG. 7 shows an example of a method executed in a computing device according to some embodiments where a database stores examples of offensive messages and a text prompt is generated in the computing device;

FIG. 8 shows an example of a method executed in a computing device according to some embodiments where a database stores examples of offensive messages and the computing device communicates with a large language model system;

FIG. 9 shows an example of a method executed in a social networking system according to some embodiments where a database stores examples of offensive comments;

FIG. 10 shows an example of a method executed in a social networking system according to some embodiments;

FIG. 11 shows an example of a method executed in a computing device according to some embodiments where a database stores examples of offensive messages or comments; and

FIG. 12 shows an example of a method executed in a computing device according to some embodiments.

### DETAILED DESCRIPTION

As required, one or more detailed embodiments of the present disclosure are disclosed herein, however, it is to be understood that the disclosed embodiments are merely exemplary of the present disclosure that may be embodied in various and alternative forms. Therefore, specific details disclosed herein are not to be interpreted as limiting, but merely as a representative basis for teaching one skilled in the art to variously employ the present disclosure.

Some embodiments comprise a computer system that prevents cyberbullying from messaging software, social network and videogames by using artificial intelligence (AI).

Nowadays, social media platforms like TikTok and Instagram do not allow insults, which has led bullies to become more sophisticated. Modern cyberbullying often relies on offensive messages with double meanings that manage to bypass the text moderation filters on social media. The text moderation of the social network systems like TikTok and Instagram detects insults but fail to detect more sophisticated offensive messages like, for example, offensive message with a double meaning.

In some embodiments, a computer system uses an artificial intelligence to detect and block such messages with double meaning.

In some embodiments, each user can customize their AI to recognize and filter offensive messages based on the type of harassment they experience. For example, users can configure the AI to block offensive messages related to obesity, gender, religion, or any other categories.

In some embodiments, when a user receives an offensive message that has passed the AI filter, he or she can use a software or app in a computing device to explain why the message is offensive and the software or app stores the offensive message and the explanation of why the message is offensive in a database of a computer system.

In some embodiments, from that moment on, the artificial intelligence used by the computer system will filter that message and other messages with similar meaning.

What follows is a real example of offensive messages that were tested in one embodiment of the present disclosure using the Google Gemini 2.0 Large Language Model (LLM), a Mac computer executing in two iPhone simulators a messaging software or app that prevents cyberbullying, the Google Firestore database, and Google Firebase cloud functions developed in Javascript.

In this real example the entire process of analyzing and filtering offensive messages using Google cloud functions and Gemini LLM took around 600 milliseconds which is an acceptable delay for a messaging software and even more acceptable for social networks.

The offensive messages of this example were published on TikTok by users in Spain in the month of March of 2025 in response to a post of a woman that suffered cyberbullying. Hundreds of online users published offensive comments, and the most “creative” offensive comment was “8M final boss” that received around 7000 likes in the social network TikTok. Although it seems unbelievable, there are thousands of people on TikTok who dedicate themselves to hit like in the most original offensive comments.

The comment “8M final boss” is offensive because it trivializes the March 8th (8M) movement, which represents the fight for women's rights, gender equality, and the eradication of violence and discrimination. In gaming, a “final boss” is the toughest enemy at the end of a game, symbolizing the ultimate challenge to defeat. Using this term in the context of 8M can imply that feminists or the woman itself are an obstacle to be beaten.

In this example using real offensive messages from TikTok, a first user from a first computing device can send an offensive message with a double meaning to a second user in a second computing device. For example, the message: “If you walk in front of my TV, I'll miss half a season.”.

This message implies that the second user would block the TV of the first user for a long time due to his or her obesity. However, at first, this message passes through the text moderation filter and/or the artificial intelligence filter and the second user receives it.

In one embodiment, when the second user gets the offensive message, he or she can open a window in a messaging software or app that uses artificial intelligence to prevent cyberbullying and enter an explanation of why the message he or she has received is offensive. For example, the second user can enter in the software or app the explanation: “It has a double meaning; it is offensive because it refers to my obesity.” In this example, the software or app stores the offensive message and the explanation of the reason of why the message is offensive in a database of a computer system.

In one embodiment, when a third user later tries to send a second message to the second user with the text “close to a cardiovascular accident” the computer system uses a customized artificial intelligence and blocks the second message and explains to the third user in his own language why the message is offensive and was blocked.

This way, in one embodiment the computer systems using a customized artificial intelligence learns from its own mistakes when the recipient of a hateful message—one that the artificial intelligence initially failed to filter—explains why the message is offensive and this information is stored in the computer system.

In some embodiments, the computer systems can use a customized artificial intelligence capable of filtering messages with a double meaning, for example in the same category or similar to the offensive messages previously received by the user, immediately after the user enters in the software or app the reason why the message he or she has received is offensive.

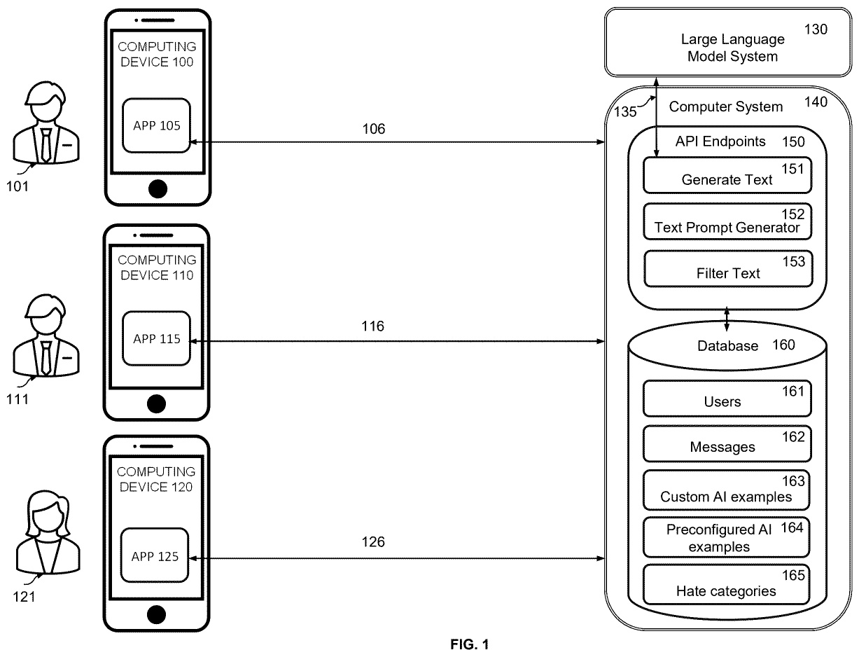

FIG. 1 shows an example of an embodiment with three users 101, 111, and 121 using three software applications or apps 105, 115, and 125 on three computing devices 100, 110, and 120, respectively.

In one embodiment, the user 111 of a computing device 110 may attempt to send an offensive message to a second recipient user 121 using a computing device 120 via the computer system 140. To do so, both computing devices 110 and 120 may run software or apps 115 and 125, respectively.

In some embodiments, the software or apps 105, 115, and 125 may be a messaging application that allows text messages and/or multimedia messages to be sent.

In other embodiments, the software or app 105, 115, and 125 may be a video game that allows sending messages, where the messages can be of two types: direct messages that a video game user sends to another video game user, and posted messages, where a video game user can send a message that is posted in a panel or window of the video game where other video game users can see it.

In other embodiments, the software or app 105, 115, and 125 may be a web browser that allows access to web pages.

In other embodiments, the software or app 105, 115, and 125 may be a social network that allows sending direct messages and also posting comments on other users' posts.

In one embodiment, the software or app 125 may be a monitoring software that allows intercepting and reading text messages and/or messages containing multimedia content that the user 121 of the computing device 120 receives. For example, the software or app 125 may monitor and read messages from messaging applications such as WhatsApp and Telegram, as well as read direct messages and comments on posts from social networks such as Instagram and TikTok.

In one embodiment, the software or app 125 may also function as a parental control. For example, the user 101 of the computing device 100 may be the father of the user 121 and use the parental control software or app 105 to monitor the text messages and/or messages containing multimedia content that arrive on the computing device 120 of his daughter.

In some embodiments, the monitoring software or app 125 may send information about social networking messages and comments received on the computing device 120 to the parental control software or app 105 of the computing device 100, for example, via the computer system 140.

In some embodiments, the monitoring software or app 125 may detect when a message or comment is offensive and may send a copy of the offensive messages and/or offensive social media comment received on the computing device 120 to the parental control software or app 105 of the computing device 100, for example, via the computer system 140.

In the example of FIG. 1, the elements 106, 116, and 126 represent communications between the computing devices 100, 110, and 120 and the computer system 140. In some embodiments, these communications 106, 116, and 126 may be communications via the Internet.

The example of FIG. 1 shows a large language model system 130. The large language model system 130 may be, for example, ChatGPT, Google Gemini, DeepSeek, Llama, or another large language model, whether open source or not.

A Large Language Model (LLM) is an artificial intelligence system based on deep neural networks, designed to process, understand, and generate natural language in a sophisticated manner. These models are trained on large volumes of textual data and use advanced machine learning techniques, particularly deep learning and transformers, to analyze and generate text with coherence and fluency comparable to that of a human.

The architecture of an LLM is based on neural network models such as Transformers, introduced in the paper “Attention Is All You Need” by Vaswani et al. (2017). These models employ self-attention mechanisms and parallel processing to handle long-range dependencies in language, allowing for more accurate contextual understanding of words and phrases.

LLMs can operate through a process of pre-training and fine-tuning:
Pre-training: In this phase, the model is trained with large amounts of text from diverse sources, such as books, scientific articles, web pages, and other documents, using word prediction or text generation tasks.
Fine-tuning: In this stage, the model is specialized for specific tasks by training with additional data and human supervision, improving its performance in particular applications.

In one embodiment, the large language model system 130 is configured to receive a text input called a text prompt and generate a text output.

The computer system 140 comprises API endpoints 150 that allows it to receive calls from the software 105, 115, and 125 and to execute programs within the API Endpoints 150 environment. In one embodiment, the API endpoints are software modules.

The example in FIG. 1 shows three endpoints named Generate Text 151, Text Prompt Generator 152, and Filter Text 153.

These endpoints 151, 152, and 153 may be, for example, REST API endpoints called from software 105, 115, or 125 running on the computing devices 100, 110 and 120, respectively.

In one embodiment, the API endpoints 150 are executed on one or more servers, which may be physical servers or servers in the form of virtual machines.

In another embodiment, the API endpoints 150 may be executed in serverless environments, such as a cloud. For example, the API endpoints 150 may consist of Firebase Cloud Functions that execute programs in the JavaScript language within the Google Cloud.

In another example, the API endpoints 150 may consist of cloud functions that run on the Google Cloud and can execute instructions programmed in various programming languages, such as JavaScript/TypeScript, Python, Go, Java, C#, or other programming languages.

In yet another example, the API endpoints 150 can be executed in Docker-like containers.

In one embodiment, the Generate Text endpoint 151 is programmed to access the Large Language Model System 130 via the communication indicated with element 135 of FIG. 1 using an API provided by the Large Language Model System 130. To do so, in some embodiments, it may use an API Key that manages authentication and/or authorization and allows the Generate Text endpoint 151 to send a text prompt to the Large Language Model System 130 and receive a response from the Large Language Model System 130.

In some embodiments, the Generate Text endpoint 151 comprises a function, such as a cloud function, that is programmed to receive a first text string as an input parameter, transmit the first text string to the Large Language Model System 130, receive a response or output in the form of a second text string from the Large Language Model System 130, and transmit the second text string generated in the Large Language Model System 130 to the system that called the function.

In one embodiment, the Text Prompt Generator endpoint 152 comprises a function, such as a cloud function, that is programmed to generate text prompts.

A text prompt is a set of instructions, questions, or input text that is provided to a large language model system for the purpose of soliciting a response based on the provided input text. Text prompts can take various forms, from simple keywords to detailed task descriptions.

Large language models use natural language processing (NLP) and deep learning techniques to interpret the text prompt and generate a coherent response based on their prior training. The process involves the following stages:
Receiving the Text Prompt: The user enters a text that defines the task or question to be solved.
Text Encoding: The model transforms the text prompt into mathematical representations understandable by the neural network.
Response Generation: Using deep neural networks, the LLM predicts the most likely response based on patterns learned from large volumes of data.
Result Delivery: The model returns a text generated based on the initial text prompt.

In one embodiment, the Filter Text 153 endpoint receives from a computing device that wishes to send a text message, for example the computing device 110, a first data that may comprise a text message and an identifier of a recipient user. The cloud function accesses the database 160 to read a second data, which comprises examples of offensive messages that may affect the recipient user, along with explanations of why these messages are offensive.

In one embodiment, the Filter Text 153 endpoint transmits the initial data to the Text Prompt Generator 152 endpoint, which generates a text prompt that includes instructions, the text message, and the second data.

The computer system 140 also comprises a database 160. For example, the database 160 may be a serverless database running in the Google Firestore environment. In some embodiments, the database 160 may be a SQL database, while in other embodiments, the database may be a NoSQL database such as MongoDB or the aforementioned Google Firestore. In one embodiment, the database 160 may store tables (using SQL database terminology) or collections (using NoSQL database terminology).

Although the example in FIG. 1 shows the API endpoints 150 and the database 160 within a computer system 140, other configurations are possible. For example, the API endpoints 150 and the database 160 may run on different servers in different data centers. In another example, API endpoints 150 and database 160 may run in different cloud-based serverless environments.

In one embodiment, the database 160 may store the tables or collections Users 161, Messages 162, Custom AI Examples 163, Preconfigured AI Examples 164 and Hate Categories 165.

In one embodiment, the Users table or collection stores information about users who use the software or app 105, 115, 125 on the computing devices 100, 110, 120. For example, the Users table or collection may store the user's name, email address, phone number, and one or more fields or data related to the use of artificial intelligence to filter offensive messages sent or received by the user.

In one embodiment, the Users table or collection may store a field or data named FilterMessagesWithAI that indicates that the Computer System 140 should filter offensive messages sent to the user using artificial intelligence.

In one embodiment, the Users table or collection may store a field or data named ShadowBan that indicates that the user has a shadow ban.

A shadow ban is a restriction discreetly applied to a user on a digital platform, limiting their visibility and reach without direct notification. Instead of blocking or deleting their account, the platform reduces the exposure of their content in search results, feeds, messages, or interactions with other users, preventing their posts or messages from having a negative impact. This practice is commonly used to mitigate abusive behavior or rule violations without alerting the affected user.

In some embodiments, when a user is shadow banned, the computer system filters all messages sent by that user using artificial intelligence, using one or more of the embodiments explained below. In one embodiment, when a user is shadow banned, the artificial intelligence applies a stricter level of filtering of offensive messages compared to the offensive messages it filters from non-shadow banned users.

In one embodiment, the Messages table or collection 162 stores messages and/or comments sent and received by users of the software or apps 105, 115, and 125.

In one embodiment, the Custom AI Examples table 163 stores information about offensive messages received by a user of software or apps 105, 115, and 125.

For example, the Custom AI Examples table 163 may store offensive messages received by the user 121 that he or she finds offensive. For example, offensive messages with a double meaning.

In one embodiment, the data stored in the Custom AI Examples table 163 comprises the text of the message the user finds offensive and an explanation or reason of why the message is offensive. In one embodiment, it is the user 121 herself who, when she receives a message through the software or app 125 that she considers offensive, enters through the software or app 125 the explanation of why the message received is offensive and the software or app 125 stores that information in the Custom AI examples table 163 of the database 160.

In one embodiment, the message received by the user 121 on the computing device 120, which she considers offensive, has been analyzed by one or more artificial intelligences that filter offensive messages without detecting that the message was offensive, and for that reason, the offensive message has reached user 121 of computing device 120.

In one embodiment, the Large Language Model System 130 may filter offensive messages directed at user 121 of computing device 120 using data from the Custom AI Examples 163 table or collection that the user entered into the database 160.

In one embodiment, the Preconfigured AI Examples 164 table or collection stores information with preconfigured examples of offensive messages and the reason why these preconfigured examples of offensive messages are offensive.

In one embodiment the registers of the table or collection Preconfigured AI examples may be associated with a category of hate or intolerance. For example, the categories of hate or intolerance may be stored in the table or collection Hate Categories 165.

In one embodiment, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In one embodiment, the user 121 of the computing device 120 uses the software or app 125 to select one or more preconfigured offensive messages that the user believes may be offensive to her. To do this, for example, the software or app 125 may display an on-screen list of preconfigured offensive messages sorted by category, and the user 121 may select preconfigured examples of offensive messages that are offensive to her. In one embodiment, the software or app 125 stores that information in the database 160.

In one embodiment, the user 121 of the computing device 120 uses the software or app 125 to select one or more hate or intolerance categories and store that information in the database 160.

In one embodiment, the computer system 140 assigns records in the Preconfigured AI Examples table 164 to the user 121 based on the hate or intolerance categories the user 121 has selected in the software or app 125.

In one embodiment, the Large Language Model System 130 may detect offensive messages directed to user 121 of computing device 120 by taking into account the Preconfigured AI examples 164 assigned by computer system 140 to the user 121 based on the hate or intolerance categories chosen by user 121.

In one embodiment, the Large Language Model System 130 may detect offensive messages directed to user 121 of computing device 120 using both Custom AI examples 163 and Preconfigured AI examples 164.

In one embodiment, the computer system 140 receives a message from computing device 110 destined for user 121 of computing device 120. The computer system accesses database 160 and reads the Custom AI Examples entered by user 121 into the database and/or the Preconfigured AI examples associated with the user 121, where said AI Examples include examples of offensive messages and explanations of why the messages are offensive.

In one embodiment, the computer system 140, using the Text Prompt Generator module or cloud function 152, generates a text prompt. For example, the text prompt comprises the following text:

### Start of the Text Prompt

Generate a JSON that returns a number between 0 and 1 with two decimal places, indicating the probability that a message is offensive, where 0 is a proper message and 1 is an offensive message. Consider the following examples when analyzing if a message is offensive:

EXAMPLE MESSAGE 1: [If you walk in front of my TV, I'll miss half a season]

ANALYSIS OF EXAMPLE 1: [It has a double meaning; it is offensive because it refers to my obesity]

EXAMPLE MESSAGE 2: [8M final boss]

ANALYSIS OF EXAMPLE 2: [it is offensive because it frames the March 8th feminist movement as an enemy to defeat rather than a legitimate fight for women's rights. In gaming, a “final boss” is the toughest opponent, so using this term can trivialize or mock the movement, making it seem like an obstacle rather than a cause for justice].

EXAMPLE MESSAGE 3: [Don't take my sandwich.].

ANALYSIS OF EXAMPLE 3: [this phrase is in a mocking tone implying that I am an overweight person and that I eat excessively, or I am always hungry, it is offensive because of my obesity].

Consider irony or double meanings in the examples when analyzing if the message is offensive.

The message to analyze is: [close to a cardiovascular accident].

If the message to analyze is identical or very similar to one of the examples, return a high score.

Return the result in JSON format with a field called points that indicates the score between 0 and 1. If the score is greater than 0.5, include a second field in the JSON called reason, with fewer than 80 characters, explaining why the message is offensive in the chosen language, but without mentioning the examples. The chosen language is English. Return only the JSON.

### End of the Text Prompt

In one embodiment, the Generate Text module or cloud function 151 receives the text prompt generated in the cloud function module 152 and transmits it to the large language model system 130.

In one embodiment, the large language model system 130 processes the text prompt and returns a text output to the computer system 140 that includes an indicator of the likelihood that the message being analyzed is offensive.

In one embodiment, the text output is a text string comprising a JSON.

JSON stands for JavaScript Object Notation and is a lightweight data exchange format. It is based on a structure of key-value pairs and ordered lists, making it easy for humans to read and write, as well as easy for machines to process.

For example, the output text generated by the large language model system 130 might contain this JSON with the following information:
{
“points”: 0.95,
“reason”: “Refers to a health condition in a potentially offensive way.”
}

In one embodiment, the Filter Text 153 module or endpoint receives the JSON response from the large language model system 130 and processes it to obtain the probability that the analyzed message is offensive. For example, by reading the points field of the JSON.

In one embodiment, the Filter Text 153 module or endpoint also processes the JSON and obtains an explanation or reason of why the message is offensive. For example, by reading the reason field of the JSON.

In one embodiment, the Filter Text 153 module or cloud function compares the value of the probability that the message is offensive to a threshold, for example 0.5, and determines that the message is offensive if the probability is greater than the threshold.

In one embodiment, the Filter Text 153 module or cloud function transmits a data to the computing device 110 indicating that the message cannot be sent because it is offensive.

In one embodiment, the Filter Text 153 module or cloud function also transmits to the computing device 110 the value of the reason field of the JSON, which contains the explanation of why the message is offensive. In this way, in the event of a false positive, user 111 of computing device 110 knows why the message has been rejected and can modify the message.

In one embodiment, if the value of the JSON points field is less than or equal to the threshold, the computer system 140 transmits the message to the computing device 120 of the user 121.

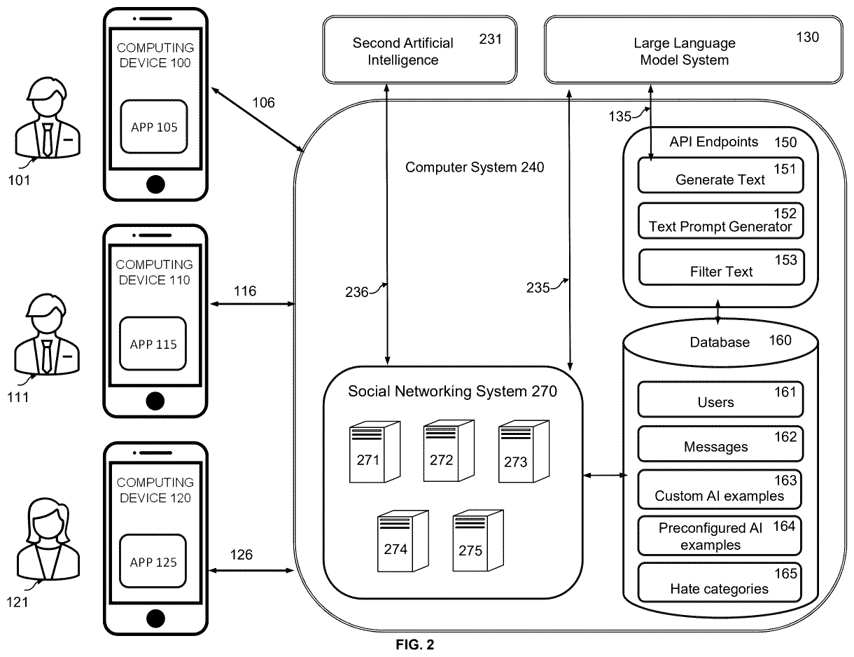

FIG. 2 shows an example of an embodiment of a computer system 240 comprising a social networking system 270.

In the example shown in FIG. 2, the social networking system 270 has five servers 271, 272, 273, 274 and 275. The social networking system 270 also has access to the database 160 where it can write data and read data.

The following describes embodiments of the social networking system 270. However, other social network embodiments are also possible, using a different number of elements and distributing the various functions between different elements in different ways.

In some embodiments, the computing devices 100, 110 and 120 may use a browser-type program or an application to communicate with the social networking system 270, for example by means of a web server 275, which allows users to register and interact with one another. The web server 275 may display web pages with different types of data for each user, including profile information, or relationships between a user and others. For example, the relationships that the user of computing device 100 has with users of computing devices 110 and 120.

In one embodiment, the server 271 performs the functions of registering, authenticating and authorizing the computing devices and/or users who use computing devices to allow them to connect and communicate with the social networking system 270 to transmit and receive data to the social networking system 270 and to other computing devices.

In some embodiments, the computing devices may transmit to the social networking site 270 data that comprises information that identifies the computing devices 100, 110 and 120 or identifies the user in the database 160. For example, the user may have registered at a web page of a web server 275 of social networking site 270, transmitting registration data which are stored in the database 160. Upon registration, the user can choose identifier data, such as for example the e-mail address or other identifier data, and a password that allows the user, for example, to access his or her data and modify them.

Once a user has registered on the social networking site 270 he or she may transmit data, such as personal information, to the social networking site 270 in the form of text messages, pictures, photos, videos, audio, URL or URI type web links, geographic data, geographic coordinates such as GPS, location data, information on events and other social data that the social networking site 270 receives and stores associated with the user in the database 160.

In some embodiments, the server 272 executes a software program editor of social relations which receives from the computing devices 100, 110 and 120, data indicating a type of relationship between users of computing devices and the software program stores in database 160 data regarding the type of relationship between the users. The editor of social relations software can also generate and send communications to the computing devices to confirm the type of social relations.

For example, users of computing devices 100 and 110 can register on the social networking site 270 using the web server 275 and select the names user 100 and user 110 respectively. Once registered, the user 100 can request to establish a relationship with the user 110 using the software program editor of social relations of the server 272. The server 272 may send a communication or message to the user 110 so that this user may confirm the relationship with the user 110. If the user 110 responds with a message or communication indicating that he or she accepts the type of social relationship created by user 110, the server 272 stores the social relationship in the database 160.

The type of relationship established between user 100 and user 110 can be, for example, being friends, belonging to the same club, team, gymnasium or school, having a subject, class or profession in common, having planned to attend or having attended to an event such as a sporting or religious event, a conference or trade show, having common hobbies or tastes, such as on a type of music or film, etc.

Each type of social network can establish different types of relationships between different social network users.

In some social networks, like X, a user can publish in the network short messages, such as for example up to 140 characters, and users who wish to receive these messages “subscribe” to the user who publishes the messages to receive them. At the same time the user who publishes the messages may also be registered to receive messages from other users. When a user has subscribed to receive messages, a “follower” type of social relationship is stored in the social network.

New types of social relationships between users can be defined in the program that runs on the server 272 assigning to each new type of relationship a unique identifier (for example an integer or alphanumeric code) and a description of the type of social relationship while storing that information in the database 160.

In some embodiments, the server 273 executes a software program that lets one see relationships between users and their associated data, such as photographs, videos and personal profile data of users who are linked between them. The server 273 also allows other functions for users to interconnect, such as users sending messages, emails or establishing voice communications, such as voice over IP (VoIP) or video communications such as videoconferences.

In some embodiments, the server 274 runs a program or software programs that allows the social networking system 270 to communicate with a software application running on a computing device.

In some social networks, social network members can join or create relationships based on groups. These groups may include people with the same interests, such as a football team, a band, a personal hobby, a brand of clothing, etc. Each user can create his own group with those who share the same interests.

Some embodiments enable the creation of various types of groups with different privacy settings and accepting new members in the group.

Some embodiments have an open public group of users who have a common interest or who want to show their affinity with the aim of the group. The open public group interactions are typically public and visible in search pages of the social network site, the content can be viewed without being a member of the page. Non-members typically cannot add content.

A “page” does not follow the typical format of the group because there are no members. Joining a “page” is typically accomplished by simply clicking on an icon on the page itself. After joining a page, a member is generally free to add content.

Other embodiments enable the creation of groups that have administrators and members.

The following are examples of groups:
Open group: Any user can join this group and invite others to do so, in this way, any user can view the information and content of the group and add their own content. Joining is automatic, so no-one needs to accept or confirm the request to join the group.
Closed or Private Group: For a new member to join the group, the group administrators must approve an application for membership. The group appears in the search engine results but the contents cannot be viewed. Any user can view the description of the group, but only members may view the contents and add new content.
Secret Group: The group does not appear as the result of a search or on the profiles of the group members. Only people who receive an invitation from a group member may join. Only members can view group information and content and add new content to the group.

In some embodiments, the administrator or administrators can change the settings of the groups so that the restrictions respect to the possibility of publishing content can vary.

The form for the creation of a group typically includes information fields such as group name, description and some relevant searchable data. In some situations, when the social site group includes an administrator, the administrator can delete or report inappropriate content.

According to other embodiments, the social network site has functionalities similar to that of X and enables the creation of a user to publish content, for example, in the form of short messages. In turn, a user can be a “follower” of another user, thus creating a link between the two of them allowing him/her to receive content that this user posts and view other users' comments to that content.

A user may directly become a “follower” of another user, without the need for the user followed to have to decide whether or not to accept that relationship. However, there may be settings that can protect publications, so that only accepted users allowed to follow these publications may see them.

User messages can be searched based on keywords or “topics”, such as, for example, messages that talk about a theme or content on a single common interest, similar to what a group would be.

In some embodiments, the social networking system 270 may be a centralized social network in which the different systems of the social network are managed by the same entity, such as a company.

Other types of social networks are decentralized social networks like Bluesky.

In some embodiments, the social networking system 270 may be a decentralized social network where the different systems in the decentralized social network may be managed by more than one entity.

Although the example in FIG. 2 shows a social network comprising a few servers, in some embodiments a centralized social network may comprise thousands of servers distributed in different datacenters, for example datacenters located in different countries.

Currently, the most popular social networks such as Facebook, Instagram, TikTok, LinkedIn and X are centralized social networks.

In one embodiment, the social networking system 270 receives a post from the computing device 120 used by the user 121.

In one embodiment, the social networking system 270 receives one or more comments to the post from other computing devices like, for example, the computing device 110 used by the user 111.

In one embodiment, the social networking system 270 access the database 160 to read custom AI examples comprising offensive comments previously published on the social networking system 270 in response to a post of the user 121 and explanations of why the previously published offensive comments are offensive.

In one embodiment, the social networking system 270 access the database 160 to read preconfigured AI examples comprising offensive comments and explanations of why the offensive comments are offensive.

In one embodiment, the social networking system generates a text prompt comprising instructions, the comment and the custom AI examples and/or the preconfigured AI examples, where the instructions are in a first human language and comprise a first instruction for a large language model system to assign a probability that the comment is offensive considering the examples of offensive comments of the custom AI examples and/or the preconfigured AI examples.

For example, in one embodiment the social networking system can generate the text prompt by executing or calling one or more of the API endpoints 150.

In one embodiment, the social networking system 270 transmits the text prompt to a large language model system 130, for example using the communication 235 of FIG. 2.

In one embodiment, the social networking system receives the output text generated by the large language model system, the output text comprising an indicator of the probability that the comment is offensive to the user 121.

In one embodiment, to improve the work of the large language model system 130, the text prompt comprises a text explanation of the post published by the user 121. In some embodiments where the post comprises a picture or a video the text explanation comprises and explanation of the picture or the video to give a context to the large language model system when analyzing a comment to detect if the comment is offensive.

In some embodiments, the explanation of the picture or the video is generated by the large language model system 130.

In some embodiments, the large language model system transmits the explanation of the picture or the video to the social networking system to include it in the text prompt.

In some embodiments, the explanation of the picture or video is generated by a second artificial intelligence 231 different than the large language model system 130. For example, a second artificial intelligence 231 specialized in generating text descriptions of pictures and/or videos.

In some embodiments, the second artificial intelligence transmits through the communication 236 the explanation of the picture or video to the social networking system 270 that includes it in the text prompt.

In some embodiments, the social networking system receives a post from the computing device 120 of the user 121 and uses the artificial intelligence of the large language model system 130 to filter offensive comments to the post published by the user 121.

In some embodiments, when the social networking system receives a comment to the post from another computing device 110 of the user 111 it accesses the database 160 and reads the custom AI examples 163 comprising offensive comments previously published in the social network system in response to a post of the user 121 and explanations of why these comments are offensive. In some embodiments the social networking system reads the preconfigured AI examples 164 comprising preconfigured examples of offensive comments and explanations of why the comments are offensive.

In some embodiments, the social networking system generates a text prompt comprising instructions, the examples of offensive comments and the comment received from the user 111, where the instructions are in a human language and comprise an instruction for the large language model 130 to assign a probability that the comment is offensive considering the examples of offensive comments and explanations read from the database.

In some embodiments, the social networking system transmits the text prompt to the large language model system 130 and receives an output text generated by the large language model system comprising an indicator of the probability that the comment is offensive.

In some embodiments, the social networking system compares the indicator with a threshold number and determines if the comment if offensive or not.

In some embodiments, if the comment is not offensive the social networking system publishes the comment.

In some embodiments, if the comment is offensive the social networking system transmits to the second computing device 110 a data that indicates that the comment cannot be published. For example, the data can comprise an explanation of why the comment is offensive.

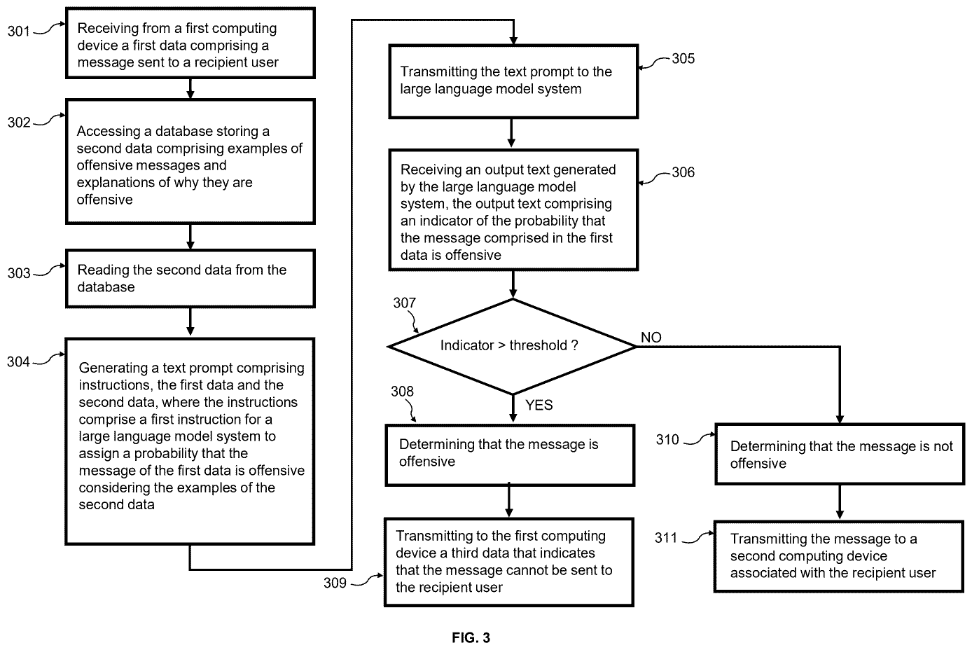

FIG. 3 shows an example of an embodiment in a computer system where a method or process is used to detect offensive messages. The method or process comprises the following steps:

At step 301 the computer system receives a first data from a first computing device, the first data comprising a message sent to a recipient user.

At step 302 the computer system accesses a database, where the database stores a second data comprising one or more examples of offensive messages and explanations of why the one or more examples of offensive messages are offensive.

At step 303 the computer system reads the second data from the database.

At step 304 the computer system generates a text prompt, the text prompt comprising instructions, the first data and the second data, where the instructions are in a first human language and comprise a first instruction for a large language model system to assign a probability that the message of the first data is offensive considering the examples of offensive messages of the second data.

At step 305 the computer system transmits the text prompt to a large language model system.

At step 306, the computer system receives the output text generated by the large language model system, the output text comprising an indicator of the probability that the message of the first data is offensive.

In some embodiments, the indicator of the probability can be a number. In other embodiments the indicator of the probability can be a string like for example “yes” or “not” or, in another example, a string with the indicator “high probability”, “medium probability” or “low probability”.

At step 307 the computer system compares the indicator with a threshold level.

If the indicator of the probability that the message is offensive is greater than the threshold level, then the process continues in step 308 where the computer system determines that the message is offensive.

At step 309 the computer system transmits to the first computing device a third data that indicates that the message cannot be sent to the recipient user.

On the contrary, if the indicator of the probability that the message is offensive is not greater than the threshold level, then the process continues at step 310 where the computer system determines that the message is not offensive.

At step 311 the computer system transmits the message to a second computing device associated with the recipient user.

In some embodiment the output text comprises an explanation of the reason why the message is offensive.

In some embodiments the third data comprises an explanation of the reason why the message is offensive.

In some embodiments, the explanations of why the one or more examples of offensive messages previously received by the recipient user are offensive are stored in the database by the recipient user. For example, entering the explanations in the software or app 125 after receiving the one or more examples of offensive messages.

In some embodiments, the instructions of the text prompt comprise a second instruction for the large language model system to consider if the message has a double meaning.

In some embodiments, the instructions of the text prompt comprise a third instruction for the large language model system to assign a high probability of the message being offensive when the message is equal or similar to the one or more examples of offensive messages previously received by the recipient user.

In some embodiments, the first data comprises an identifier of a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises the reason why the message is offensive.

In some embodiments, the first human language is the same as the second human language. In other embodiments the first human language is different than the second human language.

In some embodiments, the one or more examples of offensive messages are previously received by the recipient user.

In some embodiments, the one or more examples of offensive messages are preconfigured offensive messages.

In some embodiments, the one or more examples of offensive messages are associated with a category of hate or intolerance.

In some embodiments, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In some embodiments, the hate or intolerance category is selected by the recipient user.

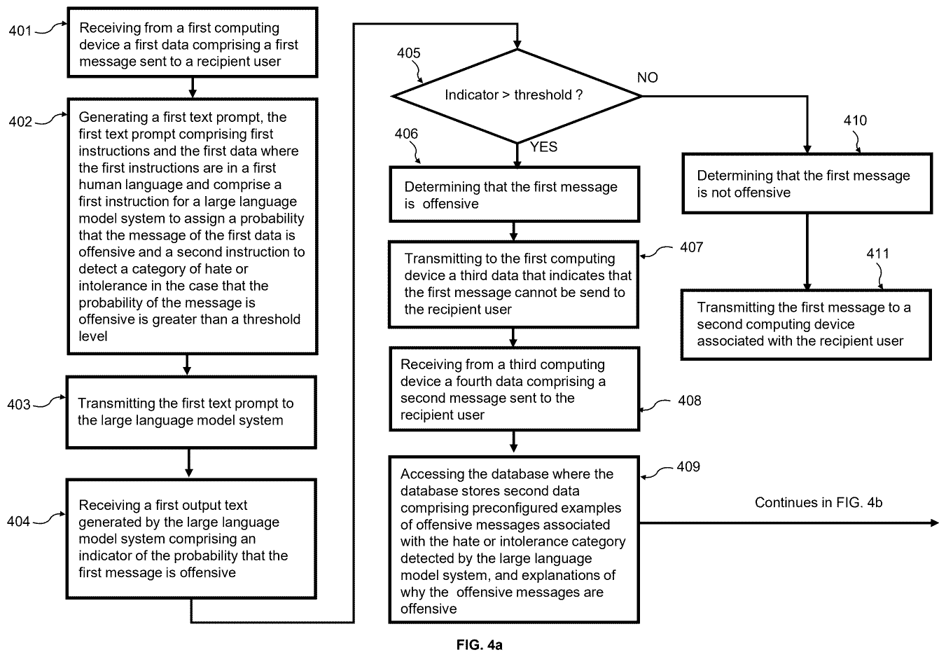

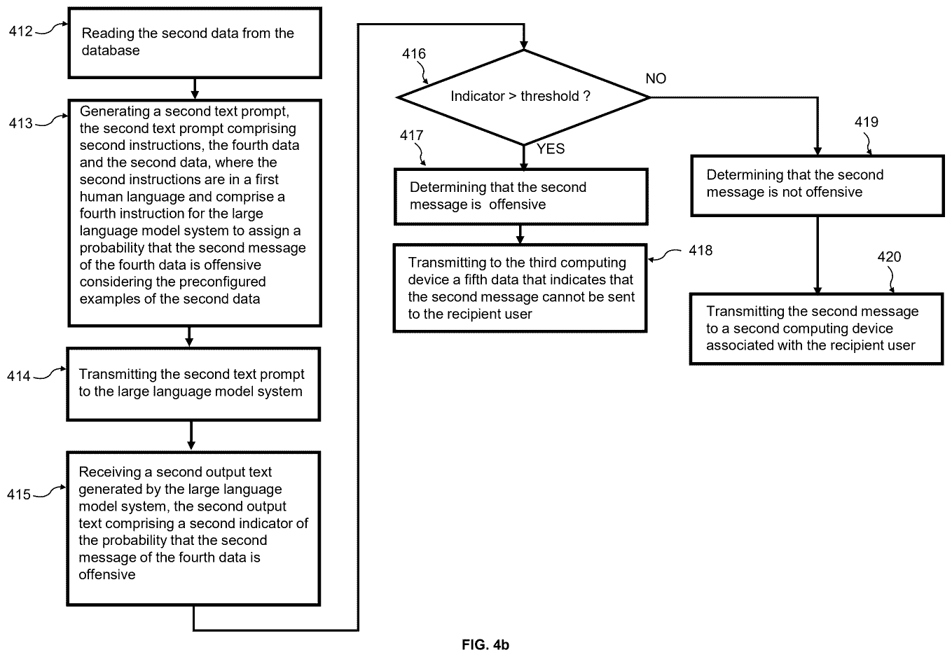

FIGS. 4a and 4b show an example of an embodiment in a computer system where a method or process is used to detect offensive messages. The method or process comprises the following steps:

At step 401 computer system receives a first data from a first computing device, the first data comprising a first message sent to a recipient user.

At step 402 the computer system generates a first text prompt, the first text prompt comprising first instructions and the first data where the first instructions are in a first human language and comprise a first instruction for a large language model system to assign a probability that the message of the first data is offensive and a second instruction to detect a category of hate or intolerance in the message of the first data in the case that the probability of the message being offensive is greater than a threshold level.

At step 403 the computer system transmits the first text prompt to the large language model system.

At step 404 the computer system receives a first output text generated by the large language model system, the first output text comprising an indicator of the probability that the first message of the first data is offensive.

In some embodiments, the indicator of the probability can be a number. In other embodiments the indicator of the probability can be a string like for example “yes” or “not” or, in another example, a string with the indicator “high probability”, “medium probability” or “low probability”.

At step 405 the computer system compares the indicator with a threshold level.

If the indicator of the probability that the message is offensive is not greater than the threshold level then the process continues at step 410 where the computer system determines that the message is not offensive.

At step 411 the computer system transmits the first message to a second computing device associated with the recipient user.

If the indicator of the probability that the message is offensive is greater than the threshold level then the process continues at step 406 where the computer system determines that the first message is offensive.

At step 407 the computer system transmits to the first computing device a third data that indicates that the message cannot be sent to the recipient user.

At step 408 the computer system receives a fourth data from a third computing device, the fourth data comprising a second message sent to the recipient user.

At step 409 the computer system accesses a database, where the database stores a second data comprising one or more preconfigured examples of offensive messages associated with the hate or intolerance category detected by the large language model system, and explanations of why the preconfigured examples of offensive messages are offensive.

At step 412 the computer system reads the second data from the database.

At step 413 the computer system generates a second text prompt, the second text prompt comprising second instructions, the fourth data and the second data, where the second instructions are in a first human language and comprise a fourth instruction for the large language model system to assign a probability that the second message of the fourth data is offensive considering the preconfigured examples of offensive messages of the second data.

At step 414 the computer system transmits the second text prompt to the large language model system.

At step 415 the computer system receives a second output text generated by the large language model system, the second output text comprising a second indicator of the probability that the second message of the fourth data is offensive.

In some embodiments the second indicator is a second number.

At step 416 the computer system compares the second indicator with a threshold level.

If the second indicator of the probability that the second message is offensive is not greater than the threshold level then the process continues at step 419 where the computer system determines that the second message is not offensive.

At step 420 the computer system transmits the second message to a second computing device associated with the recipient user.

If the second indicator of the probability that the second message is offensive is greater than the threshold level then the process continues at step 417 where the computer system determines that the second message is offensive.

At step 418 the computer system transmits to the third computing device a fifth data that indicates that the message cannot be sent to the recipient user.

In some embodiments, the first output text comprises an explanation of the reason why the first message is offensive.

In some embodiments, the third data comprises an explanation of the reason why the first message is offensive

In some embodiments, the first instructions of the first text prompt comprise a third instruction for the large language model to consider if the first message has a double meaning.

In some embodiments, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In some embodiments, the first data comprises an identifier of a second human language used in the first computing device.

In some embodiments, the first instructions of the first text prompt comprise a fourth instruction for the large language model system to use the second human language to generate at least a part of the first output text.

In some embodiments, the at least a part of the first output text generated in the second human language comprises the reason why the first message is offensive

In some embodiments, the first human language is the same as the second human language.

In some embodiments, the first human language is different than the second human language.

In some embodiments, the third computing device is different than the first computing device.

In some embodiments, the third computing device is the same as the first computing device.

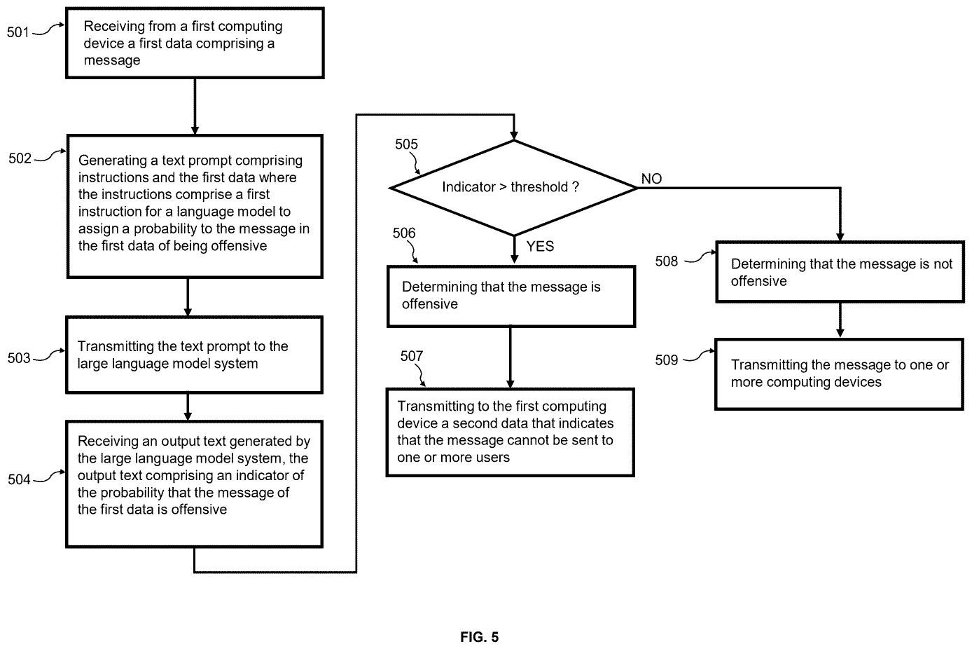

FIG. 5 shows an example of an embodiment in a computer system where a method or process is used to detect offensive messages. The method or process comprises the following steps:

At step 501 the computer system receives a first data from a first computing device, the first data comprising a message.

At step 502 the computer system generates a text prompt, the text prompt comprising instructions and the first data where the instructions are in a first human language and comprise a first instruction for a large language model system to assign a probability that the message of the first data is offensive.

At step 503 the computer system transmits the text prompt to the large language model system.

At step 504 the computer system receives an output text generated by the large language model system, the output text comprising an indicator of the probability that the message of the first data is offensive.

In some embodiments, the indicator of the probability can be a number. In other embodiments the indicator of the probability can be a string like for example “yes” or “not” or, in another example, a string with the indicator “high probability”, “medium probability” or “low probability”.

At step 505 the computer system compares the indicator in the output text with a threshold level.

If the indicator of the probability that the message is offensive is greater than the threshold level, the process continues at step 506 where the computer system determines that the message is offensive.

At step 507 the computer system transmits to the first computing device a second data that indicates that the message cannot be sent to the recipient user.

On the contrary, if the indicator of the probability that the message is offensive is not greater than the threshold level the process continues at step 508 where the computer system determines that the message is not offensive.

At step 509 the computer system transmits the message to one or more computer devices.

In some embodiments, the output text comprises an explanation of the reason why the message is offensive.

In some embodiments, the second data comprises an explanation of the reason why the message is offensive.

In some embodiments, the text prompt comprises one or more preconfigured examples of offensive messages and explanations of why the one or more preconfigured examples of offensive messages are offensive.

In some embodiments, the instructions of the text prompt comprise a second instruction for the large language model to consider if the first message has a double meaning.

In some embodiments, the instructions of the text prompt comprise a third instruction for the large language model to assign a high probability of the message being offensive when the message is equal or similar to one or more preconfigured examples of offensive messages.

In some embodiments, the first data comprises an identifier of a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises the reason why the message is offensive.

In some embodiments, the first human language is the same as the second human language.

In some embodiments, the first human language is different than the second human language.

In some embodiments, the message is addressed to one recipient user.

In some embodiments, the message is addressed to multiple users.

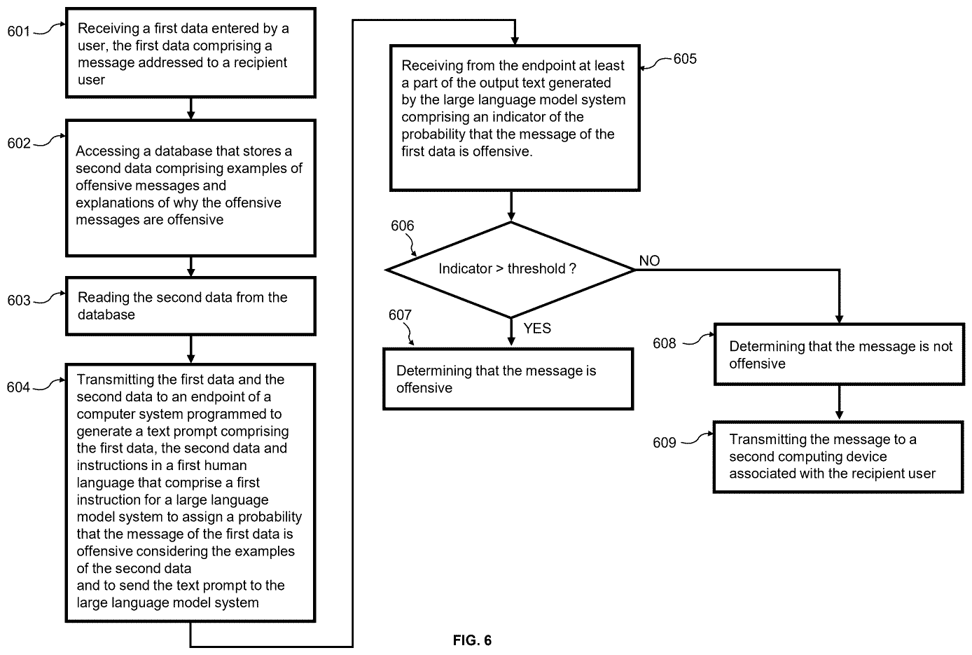

FIG. 6 shows an example of an embodiment in a computing device where a method or process is used to detect offensive messages. The method or process comprises the following steps:

At step 601 the computing device receives a first data entered by a user, the first data comprising a message addressed to a recipient user.

At step 602 the computing device access a database that stores a second data comprising one or more examples of offensive messages and explanations of why the one or more examples of offensive messages are offensive.

At step 603 the computing device reads the second data from the database.

At step 604 the computing device transmits the first data and the second data to an endpoint programmed to generate a text prompt comprising the first data, the second data and instructions in a first human language that comprise a first instruction for a large language model system to assign a probability that the message of the first data is offensive considering the one or more examples of offensive messages of the second data, and to send the text prompt to a large language model system.

At step 605 the computing devices receives from the endpoint at least a part of the output text generated by the large language model system comprising an indicator of the probability that the message of the first data is offensive.

In some embodiments, the indicator of the probability can be a number. In other embodiments the indicator of the probability can be a string like for example “yes” or “not” or, in another example, a string with the indicator “high probability”, “medium probability” or “low probability”.

At step 606 the computing device compares the indicator with a threshold level.

If the indicator of the probability that the message is offensive to the recipient user is greater than the threshold level, then the process continues in step 607 where the computing device determines that the message is offensive.

On the contrary, if the indicator of the probability that the message is offensive to the recipient user is not greater than the threshold level, then the process continues at step 608 where the computing device determines that the message is not offensive to the recipient user.

At step 609 the computing device transmits the message to a second computing device associated with the recipient user.

In some embodiments, the output text comprises an explanation of the reason why the message is offensive.

In some embodiments, the instructions of the text prompt comprise a second instruction for the large language model to consider if the message has a double meaning.

In some embodiments, the instructions of the text prompt comprise a third instruction for the large language model to assign a high probability of the message being offensive when the message is equal or similar to the one or more examples of offensive messages.

In some embodiments, the message is written in a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises the reason why the message is offensive.

In some embodiments, the first human language is the same as the second human language. In other embodiments, the first human language is different than the second human language.

In some embodiments, the one or more examples of offensive messages are previously received by the recipient user. In some embodiments, the explanations of why the one or more examples of offensive messages previously received by the recipient user are offensive are stored in the database by the recipient user.

In some embodiments, the one or more examples of offensive messages are preconfigured offensive messages.

In some embodiments, the one or more examples of offensive messages are associated with a category of hate or intolerance.

In some embodiments, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In some embodiments the hate or intolerance category is selected by the recipient user.

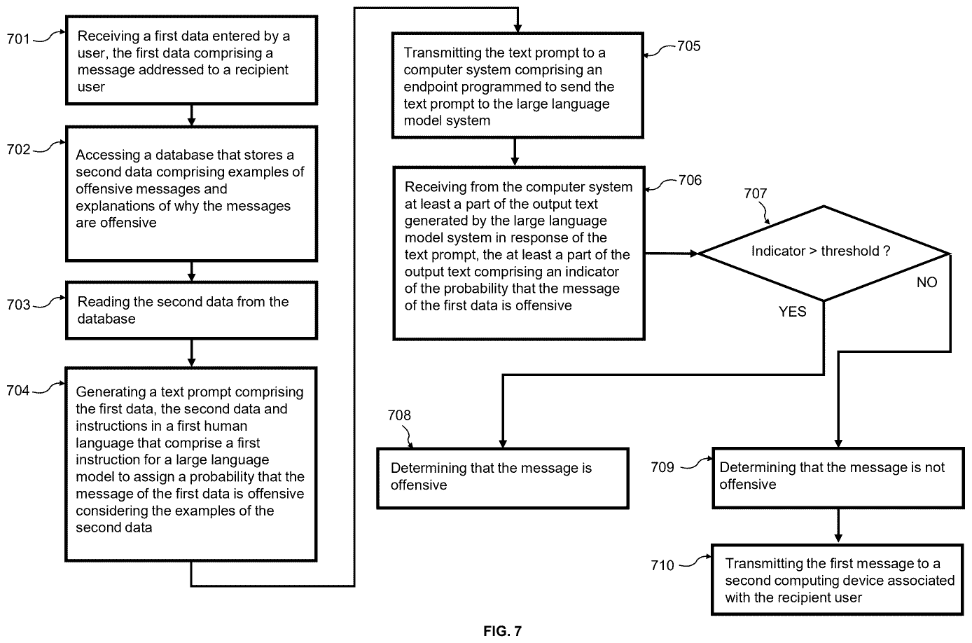

FIG. 7 shows an example of an embodiment in a computing device where a method or process is used to detect offensive messages. The method or process comprises the following steps:

At step 701 the computing device receives a first data entered by a user, the first data comprising a message addressed to a recipient user.

At step 702 the computing device access a database that stores a second data comprising one or more examples of offensive messages and explanations of why the one or more offensive messages are offensive.

At step 703 the computing device reads the second data from the database.

At step 704 the computing device generates a text prompt comprising the first data, the second data and instructions in a first human language that comprise a first instruction for a large language model to assign a probability that the message of the first data is offensive to the recipient user considering the one or more examples of offensive messages of the second data.

At step 705 the computing device transmits the text prompt to a computer system comprising an endpoint programmed to send the text prompt to the large language model system.

At step 706 the computing device receives from the computer system at least a part of the output text generated by the large language model in response to the text prompt, the at least a part of the output text comprising an indicator of the probability that the message of the first data is offensive.

At step 707 the computing device compares the indicator with a threshold level.

In some embodiments, the indicator of the probability can be a number. In other embodiments the indicator of the probability can be a string like for example “yes” or “not” or, in another example, a string with the indicator “high probability”, “medium probability” or “low probability”.

If the indicator of the probability that the message is offensive to the recipient user is greater than the threshold level, then the process continues in step 708 where the computing device determines that the message is offensive.

On the contrary, if the indicator of the probability that the message is offensive to the recipient user is not greater than the threshold level, then the process continues at step 709 where the computing device determines that the message is not offensive to the recipient user.

At step 710 the computing device transmits the message to a second computing device associated with the recipient user.

In some embodiments, the at least a part of the output text comprises an explanation of the reason why the message is offensive.

In some embodiments, the instructions of the text prompt comprise a second instruction for the large language model to consider if the message has a double meaning.

In some embodiments, the instructions of the text prompt comprise a third instruction for the large language model to assign a high probability of the message being offensive when the message is equal or similar to the one or more examples of offensive messages.

In some embodiments, the message is written in a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises the reason why the message is offensive.

In some embodiments, the first human language is the same as the second human language. In other embodiments the first human language is different than the second human language.

In some embodiments, the one or more examples of offensive messages are previously received by the recipient user. In some embodiments the explanations of why the one or more examples of offensive messages previously received by the recipient user are offensive are stored in the database by the recipient user.

In some embodiments, the one or more examples of offensive messages are preconfigured offensive messages.

In some embodiments, the one or more examples of offensive messages are associated with a category of hate or intolerance.

In some embodiments, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In some embodiments, the hate or intolerance category is selected by the recipient user.

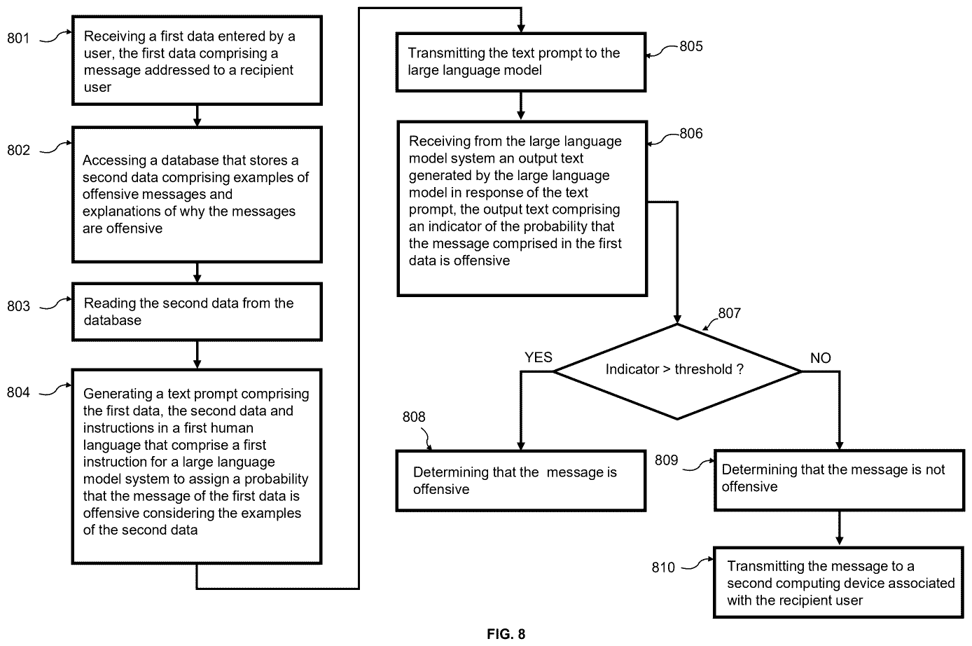

FIG. 8 shows an example of an embodiment in a computing device where a method or process is used to detect offensive messages. The method or process comprises the following steps:

At step 801 the computing device receives a first data entered by a user, the first data comprising a message addressed to a recipient user.

At step 802 the computing device access a database that stores a second data comprising one or more examples of offensive messages and explanations of why the one or more examples of offensive messages are offensive.

At step 803 the computing device reads the second data from the database.

At step 804 the computing device generates a text prompt comprising the first data, the second data and instructions in a first human language that comprise a first instruction for a large language model to assign a probability that the message of the first data is offensive considering the examples of the second data.

At step 805 the computing device transmits the text prompt to a large language model system.

At step 806 the computing device receives from the large language model an output text generated by the large language model system in response to the text prompt, the output text comprising an indicator of the probability that the message of the first data is offensive.

At step 807 the computing device compares the indicator with a threshold level.

In some embodiments, the indicator of the probability can be a number. In other embodiments the indicator of the probability can be a string like for example “yes” or “not” or, in another example, a string with the indicator “high probability”, “medium probability” or “low probability”.

If the indicator of the probability that the message is offensive is greater than the threshold level, then the process continues in step 808 where the computing device determines that the message is offensive.

On the contrary, if the indicator of probability that the message is offensive is not greater than the threshold level, then the process continues at step 809 where the computing device determines that the message is not offensive.

At step 810 the computing device transmits the message to a second computing device associated with the recipient user.

In some embodiments, the output text comprises an explanation of the reason why the message is offensive.

In some embodiments, the instructions of the text prompt comprise a second instruction for the large language model system to consider if the message has a double meaning.

In some embodiments, the instructions of the text prompt comprise a third instruction for the large language model to assign a high probability of the message being offensive when the message is equal or similar to the one or more examples of offensive messages.

In some embodiments, the first data comprises an identifier of a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises the reason why the message is offensive.

In some embodiments, the first human language is the same as the second human language. In other embodiments, the first human language is different than the second human language.

In some embodiments, the one or more examples of offensive messages are previously received by the recipient user. In some embodiments, the explanations of why the one or more examples of offensive messages previously received by the recipient user are offensive are stored in the database by the recipient user.

In some embodiments, the one or more examples of offensive messages are preconfigured offensive messages.

In some embodiments, the one or more examples of offensive messages are associated with a category of hate or intolerance.

In some embodiments, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In some embodiments, the hate or intolerance category is selected by the recipient user.

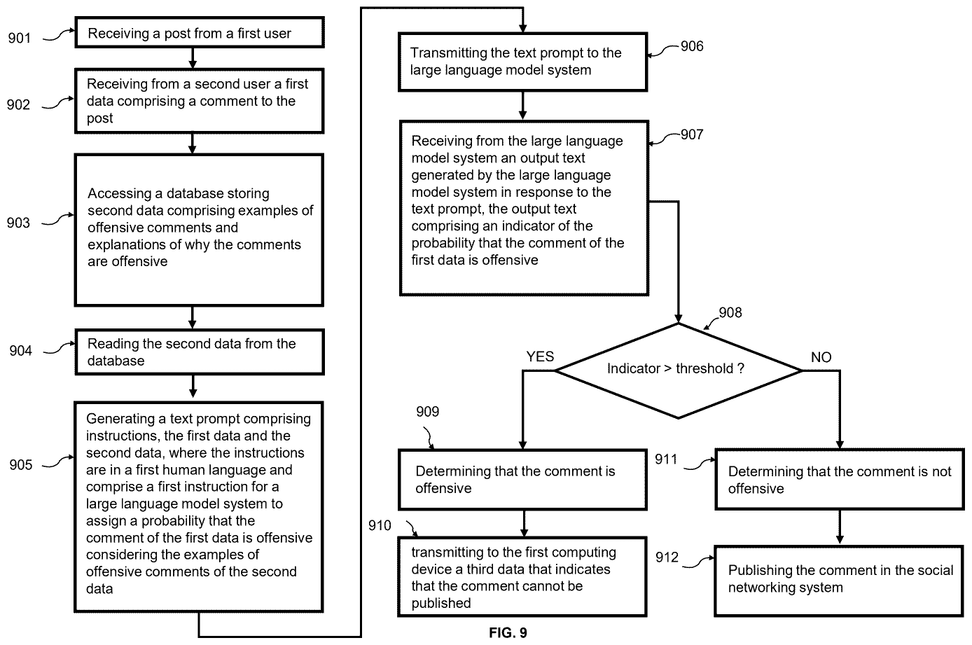

FIG. 9 shows an example of an embodiment in a social networking system where a method or process is used to detect offensive comments. The method or process comprises the following steps:

At step 901 the social networking systems receives a post from a first user. The post can be a text post or a multimedia post comprising an image and/or a video.

At step 902 the social networking system receives from a second user using a first computing device a first data comprising a comment to the post.

At step 903 the social networking system access a database, where the database stores second data comprising one or more examples of offensive comments and explanations of why the one or more examples of offensive comments are offensive.

At step 904 the social networking system reads the second data from the database.

At step 905 the social networking system generates a text prompt, the text prompt comprising instructions, the first data and the second data, where the instructions are in a first human language and comprise a first instruction for a large language model system to assign a probability that the comment of the first data is offensive considering the one or more examples of offensive comments of the second data.

At step 906 the social networking system transmits the text prompt to a large language model system.

At step 907 the social networking system receives the output text generated by the large language model system in response to the text prompt, the output text comprising an indicator of the probability that the comment of the first data is offensive.

In some embodiments, the indicator of the probability can be a number. In other embodiments the indicator of the probability can be a string like for example “yes” or “not” or, in another example, a string with the indicator “high probability”, “medium probability” or “low probability”.

At step 908 the social networking system compares the number in the output text with a threshold level.

If the indicator of the probability that the comment is offensive is greater than the threshold level, then the process continues at step 909 where the social networking system determines that the comment is offensive.

At step 910 the social networking system may transmit to the first computing device a third data that indicates that the comment cannot be published.

On the contrary, if the indicator of the probability that the comment is offensive is not greater than the threshold level, then the process continues at step 911 where the social networking system determines that the comment is not offensive.

At step 912 the social networking system publishes the comment.

In some embodiments, the output text comprises an explanation of the reason why the comment is offensive.

In some embodiments, the third data comprises an explanation of the reason why the comment is offensive.

In some embodiments, the explanation of the reason why the comment is offensive is in the first human language.

In some embodiments, the instructions of the text prompt comprise a second instruction for the large language model to consider if the comment has a double meaning.

In some embodiments, the instructions of the text prompt comprise a third instruction for the large language model to assign a high probability of the comment being offensive when the comment is equal or similar to the examples of offensive comments.

In some embodiments, the first data comprises an identifier of a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises a reason why the message is offensive.

In some embodiments, the first human language is the same as the second human language.

In some embodiments, the first human language is different than the second human language.

In some embodiments, the post comprises a picture and the text prompt comprises an explanation of the picture.

In some embodiments, the explanation of the picture is generated by the large language model system.

In some embodiments, the social networking system receives the explanation of the picture from the large language model system and includes it in the text prompt.

In some embodiments, the explanation of the picture is generated in a second artificial intelligence different than the large language model system.

In some embodiments, the social networking system receives the explanation of the picture from the second artificial intelligence and includes it in the text prompt.

In some embodiments, the post comprises a video and the text prompt comprises an explanation of the video.

In some embodiments, the explanation of the video is generated by the large language model system.

In some embodiments, the social networking system receives the explanation of the video from the large language model system and includes it in the text prompt.

In some embodiments, the explanation of the video is generated in a second artificial intelligence different than the large language model system.

In some embodiments, the social networking system receives the explanation of the video from the second artificial intelligence and includes it in the text prompt.

In some embodiments, the one or more examples of offensive comments are previously published in the social networking system in response to the post or in response to a previous post of the first user.

In some embodiments, the one or more examples of offensive comments are preconfigured offensive comments.

In some embodiments, the one or more examples of offensive comments are associated with a category of hate or intolerance.

In some embodiments, the hate or intolerance category pertains to one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

In some embodiments, the hate or intolerance category is selected by the recipient user.

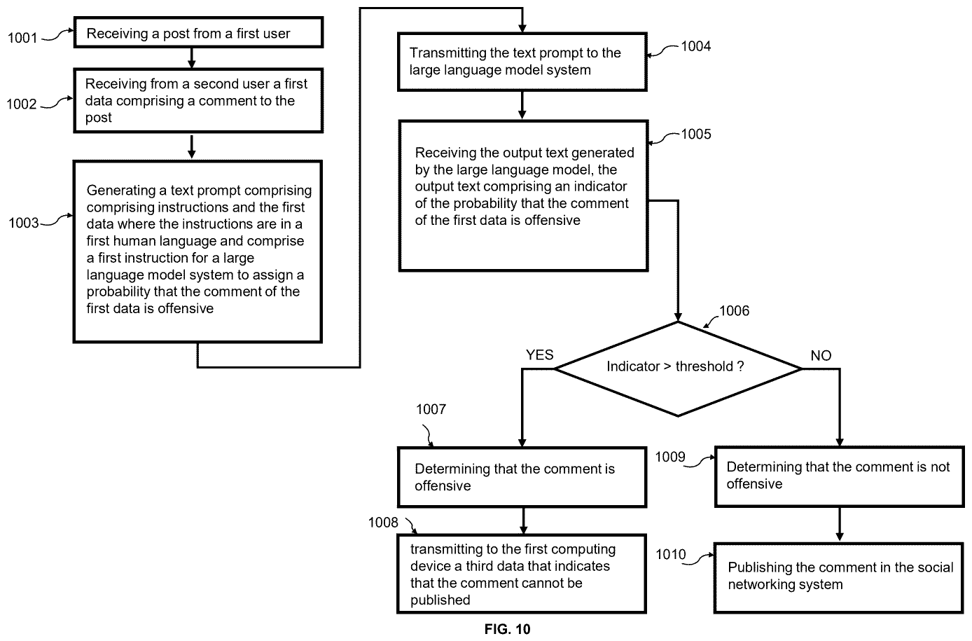

FIG. 10 shows an example of an embodiment in a social networking system where a method or process is used to detect offensive comments. The method or process comprises the following steps:

At step 1001 the social networking systems receives a post from a first user. The post can be a text post or a multimedia post comprising an image and/or a video.

At step 1002 the social networking system receives from a second user using a first computing device a first data comprising a comment to the post.

At step 1003 the social networking system generates a text prompt, the text prompt comprising instructions and the first data where the instructions are in a first human language and comprise a first instruction for a large language model system to assign a probability that the comment of the first data is offensive.

At step 1004 the social networking system transmits the text prompt to a large language model system.

At step 1005 the social networking system receives the output text generated by the large language model system in response to the text prompt, the output text comprising an indicator of the probability that the comment of the first data is offensive.

In some embodiments, the indicator of the probability can be a number. In other embodiments the indicator of the probability can be a string like for example “yes” or “not” or, in another example, a string with the indicator “high probability”, “medium probability” or “low probability”.

At step 1006 the social networking system compares the number in the output text with a threshold level.

If the indicator of the probability that the comment is offensive is greater than the threshold level, then the process continues at step 1007 where the social networking system determines that the comment is offensive.

At step 1008 the social networking system may transmit to the first computing device a third data that indicates that the comment cannot be published.

On the contrary, if the indicator of the probability that the comment is offensive is not greater than the threshold level, then the process continues at step 1009 where the social networking system determines that the comment is not offensive.

At step 1010 the social networking system publishes the comment.

In some embodiments, the output text comprises an explanation of the reason why the comment is offensive.

In some embodiments, the instructions of the text prompt comprise a second instruction for the large language model to consider if the comment has a double meaning.

In some embodiments, the first data comprises an identifier of a second human language used in the first computing device.

In some embodiments, the instructions of the text prompt comprise a fourth instruction for the large language model system to use the second human language to generate at least a part of the output text.

In some embodiments, the at least a part of the output text generated in the second human language comprises a reason why the message is offensive.

In some embodiments, the first human language is the same as the second human language.

In some embodiments, the first human language is different than the second human language.

In some embodiments, the post comprises a picture and the text prompt comprises an explanation of the picture.

In some embodiments, the explanation of the picture is generated by the large language model system.

In some embodiments, the social networking system receives the explanation of the picture from the large language model system and includes it in the text prompt.

In some embodiments, the explanation of the picture is generated in a second artificial intelligence different than the large language model system.

In some embodiments, the social networking system receives the explanation of the picture from the second artificial intelligence and includes it in the text prompt.

In some embodiments, the post comprises a video and the text prompt comprises an explanation of the video.

In some embodiments, the explanation of the video is generated by the large language model system.

In some embodiments, the social networking system receives the explanation of the video from the large language model system and includes it in the text prompt.

In some embodiments, the explanation of the video is generated in a second artificial intelligence different than the large language model system.

In some embodiments, the social networking system receives the explanation of the video from the second artificial intelligence and includes it in the text prompt.

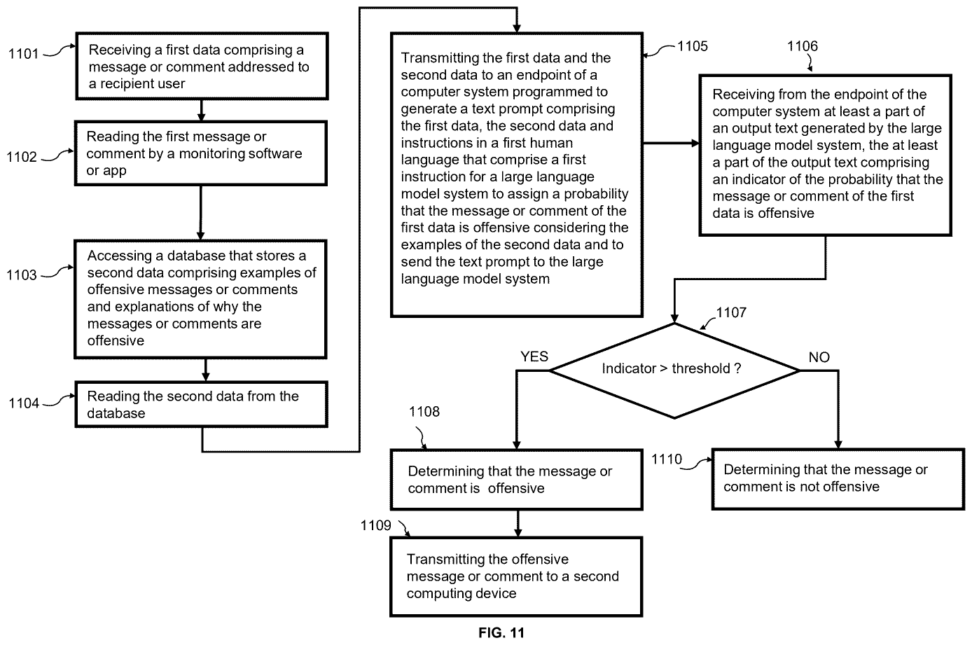

FIG. 11 shows an example of an embodiment of a process or method to transmit offensive messages or comments from a first computing device to a second computing device. The method or process comprises the following steps:

At step 1101 the first computing device receives a first data comprising a message or comment addressed to a recipient user.

At step 1102 the first computing device reads the message or comment using a monitoring software or app.

At step 1103 the first computing device access a database, where the database stores a second data comprising one or more examples of offensive messages or comments and explanations of why the one or more examples of offensive messages or comments are offensive.

At step 1104 the first computing device reads the second data from the database.

At step 1105 the first computing device transmits the first data and the second data to an endpoint of a computer system programmed to generate a text prompt comprising the first data, the second data and instructions in a first human language that comprise a first instruction for a large language model system to assign a probability that the message or comment of the first data is offensive considering the one or more examples of offensive messages or comments of the second data and to send the text prompt to the large language model system.

At step 1106 the first computing device receives from the endpoint of the computer system at least a part of an output text generated by the large language model system, the at least a part of the output text comprising an indicator of the probability that the message or comment of the first data is offensive.

At step 1107 the first computing device compares the number in the at least a part output text with a threshold level.

If the indicator of the probability that the message or comment is offensive is greater than the threshold level, then the process continues at step 1108 where the first computing device determines that the message or comment is offensive.

At step 1109 the first computing device transmits the offensive message or comment to a second computing device.

On the contrary, if the indicator of the probability that the message or comment is offensive is not greater than the threshold level, then the process continues at step 1110 where the computing device determines that the message or comment is not offensive.

In some embodiments, the second computing device executes a parental control software or app.

In some embodiments, the examples of offensive messages or comments comprise messages or comments previously received by the recipient user.

In some embodiments, the examples of offensive messages or comments comprise preconfigured examples of offensive messages or comments.

In some embodiments, the preconfigured examples of offensive messages or comments are associated with a category of hate or intolerance.

In some embodiments, the message or comment is published in a social network.

In some embodiments, the message or comment is published in the social network associated with a post previously published in the social network by the recipient user.

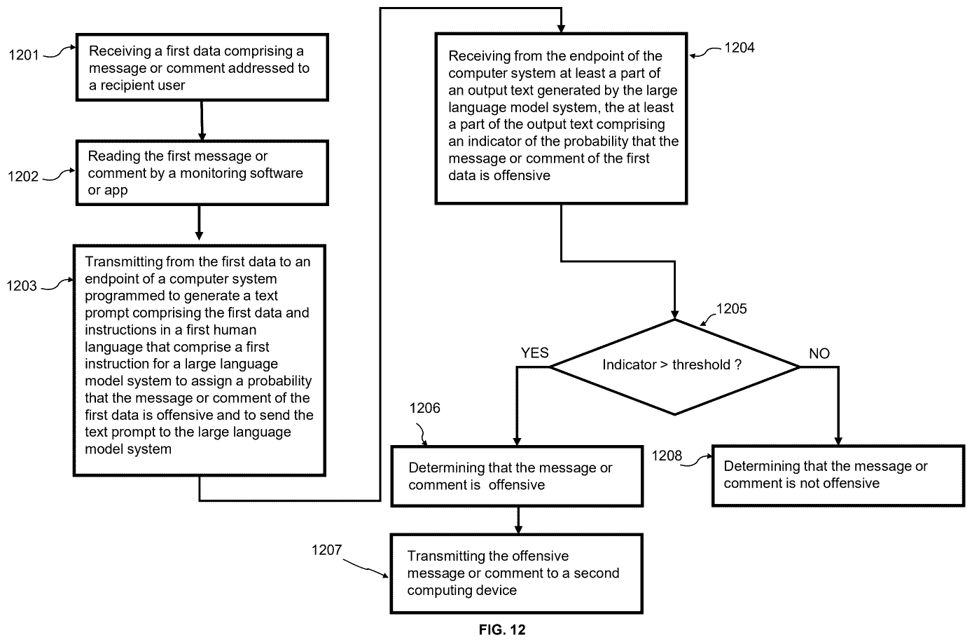

FIG. 12 shows an example of an embodiment of a process or method to transmit offensive messages or comments from a first computing device to a second computing device. The method or process comprises the following steps:

At step 1201 the first computing device receives a first data comprising a message or comment addressed to a recipient user.

At step 1202 the first computing device reads the message or comment using a monitoring software or app.

At step 1203 the first computing device transmits the first data to an endpoint of a computer system programmed to generate a text prompt comprising the first data and instructions in a first human language that comprise a first instruction for a large language model system to assign a probability that the message or comment of the first data is offensive and to send the text prompt to the large language model system.

At step 1204 the first computing device receives from the endpoint of the computer system at least a part of an output text generated by the large language model system, the at least a part of the output text comprising an indicator of the probability that the message or comment of the first data is offensive.

At step 1205 the first computing device compares the number in the at least a part output text with a threshold level.

If the indicator of the probability that the message or comment is offensive is greater than the threshold level, then the process continues at step 1206 where the first computing device determines that the message or comment is offensive.

At step 1207 the first computing device transmits the offensive message or comment to a second computing device.

On the contrary, if the indicator of the probability that the message or comment is offensive is not greater than the threshold level, then the process continues at step 1208 where the computing device determines that the message or comment is not offensive.

In some embodiments, the second computing device executes a parental control software or app.

In some embodiments, the message or comment is published in a social network.

In some embodiments, the message or comment is published in the social network associated with a post previously published in the social network by the recipient user.

While one or more exemplary embodiments are described above, it is not intended that these embodiments describe all possible forms of the present disclosure. Rather, the words used in the specification are words of description rather than limitation, and it is understood that various changes may be made without departing from the spirit and scope of the present disclosure.

With regard to any processes, systems, methods, heuristics, etc., described herein, it should be understood that, although the steps of such processes, etc., have been described as occurring according to a certain ordered sequence, such processes could be practiced with the described steps performed in an order other than the order described herein. It should be further understood that certain steps could be performed simultaneously, that other steps could be added, or that certain steps described herein could be omitted. In other words, the descriptions of processes described above are provided for the purpose of illustrating certain embodiments, and should in no way be construed so as to limit the claims.

As used in this specification and claims, the terms “for example” (“e.g.”), “for instance”, “such as”, and “like”, and the verbs “comprising”, “having”, “including”, and their other verb forms, when used in conjunction with a listing of one or more carriers or other items, are each to be construed as open-ended, meaning that the listing is not to be considered as excluding other, additional carriers or items. Other terms are to be construed using their broadest reasonable meaning unless they are used in a context that requires a different interpretation.

What is claimed is:

1. A computer-implemented method for detecting offensive messages in a computer system, the method comprising:
receiving in the computer system a first data from a first computing device, the first data comprising a message sent to a recipient user;
accessing a database from the computer system, where the database stores a second data comprising one or more examples of offensive messages and explanations of why the one or more examples of offensive messages are offensive;
reading in the computer system the second data from the database;
generating in the computer system a text prompt, the text prompt comprising instructions, the first data, and the second data, where the instructions are in a first human language and comprise a first instruction for a large language model system to assign a probability that the message of the first data is offensive considering the one or more examples of offensive messages of the second data;
transmitting from the computer system the text prompt to the large language model system; and
receiving in the computer system an output text generated by the large language model system, the output text comprising an indicator of the probability that the message of the first data is offensive.

2. The method of claim 1, wherein the indicator is a number.

3. The method of claim 2, further comprising:
comparing in the computer system the number of the output text with a threshold level;
determining in the computer system that the message of the first data is not offensive; and
transmitting from the computer system the message of the first data to a second computing device associated with the recipient user.

4. The method of claim 2, further comprising:
comparing in the computer system the number of the output text with a threshold level;
determining in the computer system that the message of the first data is offensive; and
transmitting from the computer system to the first computing device a third data that indicates that the message of the first data cannot be sent to the recipient user.

5. The method of claim 1, wherein the output text further comprises an explanation of the reason why the message is offensive.

6. The method of claim 4, wherein the third data comprises an explanation of the reason why the message is offensive.

7. The method of claim 1, wherein the explanations of why the one or more examples of offensive messages are offensive are previously received by the recipient user and are stored in the database by the recipient user.

8. The method of claim 1, wherein the instructions of the text prompt further comprise a second instruction for the large language model to consider if the message of the first data has a double meaning.

9. The method of claim 8, wherein the instructions of the text prompt further comprise a third instruction for the large language model to assign a high probability of the message of the first data being offensive when the message is equal or similar to the one or more examples of offensive messages of the second data.

10. The method of claim 4, wherein the first data further comprises an identifier of a second human language used in the first computing device.

11. The method of claim 9, wherein the instructions of the text prompt further comprise a fourth instruction for the large language model system to use a second human language to generate at least a part of the output text.

12. The method of claim 11, wherein the at least a part of the output text generated in the second human language comprises the reason why the message is offensive.

13. The method of claim 12, wherein the first human language is the same as the second human language.

14. The method of claim 12, wherein the first human language is different than the second human language.

15. The method of claim 1, wherein the one or more examples of offensive messages of the second data are previously received by the recipient user.

16. The method of claim 1, wherein the one or more examples of offensive messages of the second data are preconfigured offensive messages.

17. The method of claim 16, wherein the one or more examples of offensive messages of the second data are associated with a category of hate or intolerance.

18. The method of claim 17, wherein the hate or intolerance category pertains to at least one of the following categories: fatphobia, islamophobia, homophobia, transphobia, xenophobia, racism, sexism, ableism, ageism, antisemitism, misogyny, misandry, Afrophobia, Sinophobia, Hispanophobia, Christo phobia, indigen phobia, or antiziganism.

19. The method of claim 17, wherein the hate or intolerance category is selected by the recipient user.
